(19) United States
(12) Patent Application Publication
(10) Pub. No.: US 2007/0221319 A1
(43) Pub. Date: Sep. 27, 2007

(54) Method of Removing Labels from a Backing Web

(75) Inventor: Alex Morgan, Borrowash (GB)

Correspondence Address: FISH & RICHARDSON PC, P.O. BOX 1022, MINNEAPOLIS, MN, 55440-1022, US

(73) Assignee: MARKEM TECHNOLOGIES LTD, Nottingham (GB)

(21) Appl. No.: 11/680,673

(22) Filed: Mar. 1, 2007

(30) Foreign Application Priority Data
Mar. 2, 2006 (GB) GB0604172.7

(51) Int. Cl. B32B 37/00; B65C 9/18; B29C 63/00

(52) U.S. Cl. 156/249; 156/344; 156/541; 156/584

(57) ABSTRACT

A method of removing a label from an elongate backing web includes the steps of feeding the backing web in a first feed direction, with the label releasably adhered to the backing web, to feed the label past a label removing device whilst the label removing device is in an inoperative condition, reversing the feed direction of the backing web to feed the backing web in a second direction whilst the label removing device is in an operative condition to feed the label back past the operative label removing device, thus to cause the label to be removed from the backing web.

### RELATED APPLICATIONS

Under 35 U.S.C § 119, this application claims the benefit of a foreign priority application filed in United Kingdom, serial number GB0604172.7, filed Mar. 2, 2006.

### BACKGROUND TO THE INVENTION

This invention relates to a method of removing a label from a backing web. In this specification by “label” we include a patch which may carry information, as well as a patch which may include a data carrying device such as a radio frequency identification device (“RFID”).

It is known to provide labels releasably adhered to one side surface of a continuous elongate backing web which is stored on a storage spool of a label handling apparatus. The backing web passes around a label feed path to a take-up spool and in use one or both of the spools are rotated and/or a capstan drive roller is rotated, to feed the backing web from the storage spool to the take-up spool.

Typically the backing web passes through a station where the labels may be printed upon by a print head and/or programmed by an RFID programming device for example, and after printing/programming the labels are removed from the backing web and provided to a label applicator which is operative to apply the labels to articles, such as for example, packages which are conveyed past the label applicator. The label receiving side surface of the backing web typically is coated with a release substance and the labels are removed from the side surface by feeding the backing web around a sharp discontinuity of the label handling apparatus. This causes the leading edges of the labels to lift from the backing web, and continued feeding movement of the backing web causes the labels to be peeled from the backing web.

Because the labels when thus removed from the backing web will have a sticky surface, careful handling of the labels is required to prevent them adhering undesirably to other surfaces. Accordingly the direction in which the labels are fed as they are removed from the backing web, to the label applicator, is critical for the successful application of the labels to the articles.

In a packaging context, where articles are conveyed past the label applying apparatus, conventionally a label handling apparatus needs to be handed for proper operation at one side of the conveyor, so that the labels are fed, as they are removed from the backing web, in a direction appropriate for their application to packages. If it is desired to use the label handling apparatus for example at an opposite side of the conveyor, conventionally the apparatus requires substantial reconfiguration or “re-handling”.

### SUMMARY OF THE INVENTION

According to a first aspect of the invention we provide a method of removing a label from an elongate backing web. The method may include the steps of feeding the backing web in a first feed direction, with the label releasably adhered to the backing web, to feed the label past a label removing device whilst the label removing device is in an inoperative condition, reversing the feed direction of the backing web to feed the backing web in a second direction whilst the label removing device is in the operative condition to feed the label back past the operative label removing device, thus to cause the label to be removed from the backing web.

Thus utilizing the present invention, by reversing the web feed direction, a label may be removed from its backing web and fed in a label remove direction e.g. to a label applicator for application to an article, or the label may be removed conventionally without reversing the web feed direction, to feed the label in a different label remove direction, e.g. to a label applying apparatus. Thus the present invention enables the same label handling apparatus to be used in different locations and orientations without requiring any substantial re-handing of the apparatus.

A preferred method includes the step of moving the label removing device from the inoperative condition to the operative condition prior to a leading edge of the label to be removed passing back beyond the label removing device when the feed direction is reversed.

The label removing device may include a beak over which the backing web passes when the label removing device is in an operative condition and the feed direction is reversed, with the beak at an opposite side surface of the backing web to the label, the beak providing sharp discontinuity which causes the leading edge of the label to lift from the backing web, the continued reversed feed direction movement of the backing web peeling the label from the backing web. The label removing device may be rotatable between its inoperative and operative positions, e.g. about an axis of rotation which is generally perpendicular to the directions of label feed.

The method of the invention may include performing a work operation on the label e.g. printing and/or programming, while the backing web and label are upstream of the label removing device, e.g. while the backing web and label are moved in the first feed direction, and thus the label on which the work operation has been performed is fed past the label removing device and subsequently removed from the backing web and for example, fed to a label applicator which applies the label to an article. In another example, the method may include halting the backing web and label feed in the first direction whilst a work operation is performed on the label e.g. by moving a print head relative to the label whilst effecting printing on the label, and then recommencing backing web and label feed in the first direction to feed the label past the label removing device.

Where the label handling device includes a label removing member for removing labels when the backing web with labels is fed in the first feed direction, the method of the invention may include removing or disabling such label removing member so that labels are not removed from the backing web when the backing web is fed in the first direction.

The method of the invention may include, subsequent to feeding the backing web in the second, reverse, feed direction to remove a label, feeding the backing web in the first feed direction to advance a further label releasably adhered to the backing web past the label removing device.

According to a second aspect of the invention we provide a label handling apparatus including a storage spool for elongate backing web to which a plurality of labels are releasably adhered, and a take-up spool for backing web from which labels have been removed, a motive device operative to feed the backing web in a first feed direction, with the labels releasably adhered to the backing web, past a label removing device whilst the label removing device is in an inoperative condition. The motive device may be operable to reverse the feed direction of the backing web to feed the backing web in a second direction whilst the label removing device is in an operative condition to feed labels back past the operative label removing device, thus to cause the labels to be removed from the back web.

The apparatus may have any of the features of the apparatus described for use in the method of the first aspect of the invention, and particularly a motive device to move the label removing device between its operative and inoperative conditions.

According to a third aspect of the invention we provide a method of adapting a label handling apparatus which is configured for use in one orientation for use in an alternative orientation. The appartus may include a motive device which is operable to feed elongate backing web on which a plurality of labels are releasably adhered in a first direction and in a second direction, and a label removing member which is operable when the backing web and labels are fed in the first feed direction to remove labels from the backing web and to enable the removed labels to be fed in one label remove direction, the method including removing or disabling the label removing member, and operating a label removing device which is moveable between an inoperative condition in which when backing web and labels are fed past the label removing device in the first feed direction the label removing device is inoperative to remove labels from the backing web, and an operative condition in which when backing web and labels are fed past the label removing device in the second feed direction the label removing device is operative to remove labels from the backing web and removed labels are fed in an alternative label remove direction.

### BRIEF DESCRIPTION OF THE DRAWINGS

Embodiments of the invention will now be described with reference to the accompanying drawings in which:

FIG. 1 is an illustrative view of a label handling apparatus which may be operated by the method of the invention shown configured for use in one orientation with a backing web and label moving in a first feed direction;

FIG. 2a is a view similar to FIG. 1 but of part of the apparatus only, showing the apparatus configured for use in another orientation with a backing web and label moving in a first fee direction;

FIG. 2b is a view similar to FIG. 2A with a backing web and label moving in a first feed direction.

### DESCRIPTION OF THE PREFERRED EMBODIMENTS

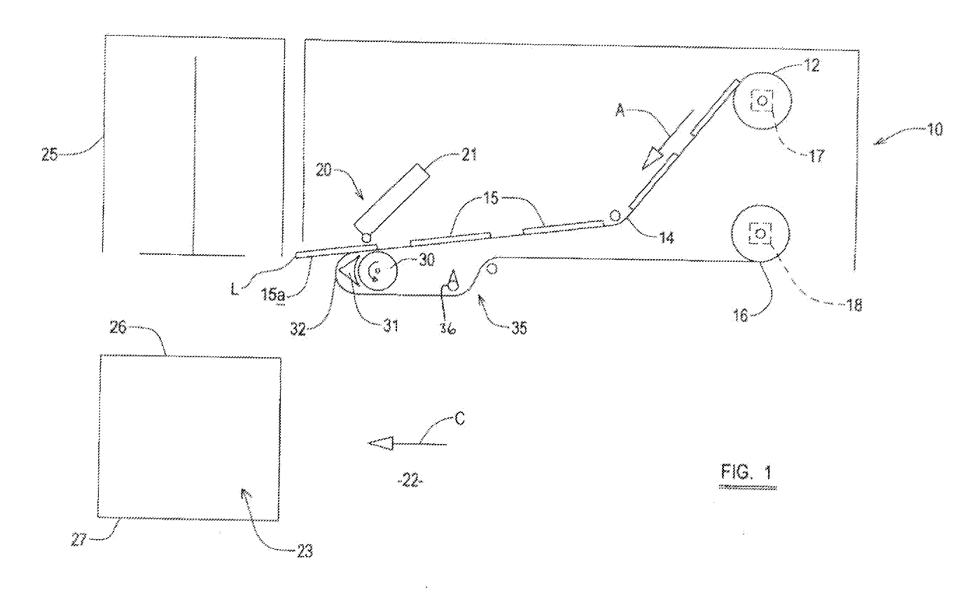

Referring to FIG. 1 of the drawings there is shown a label handling apparatus 10 which includes a storage spool 12 for storing a supply of elongate backing web 14 which has releasably adhered to one side surface thereof a plurality of labels 15. The side surface of the backing web 14 to which the labels are releasably adhered is coated with a release substance, such as a dry waxy substance which permits of the peeling of the labels 15 from the backing web 14 as hereinafter described.

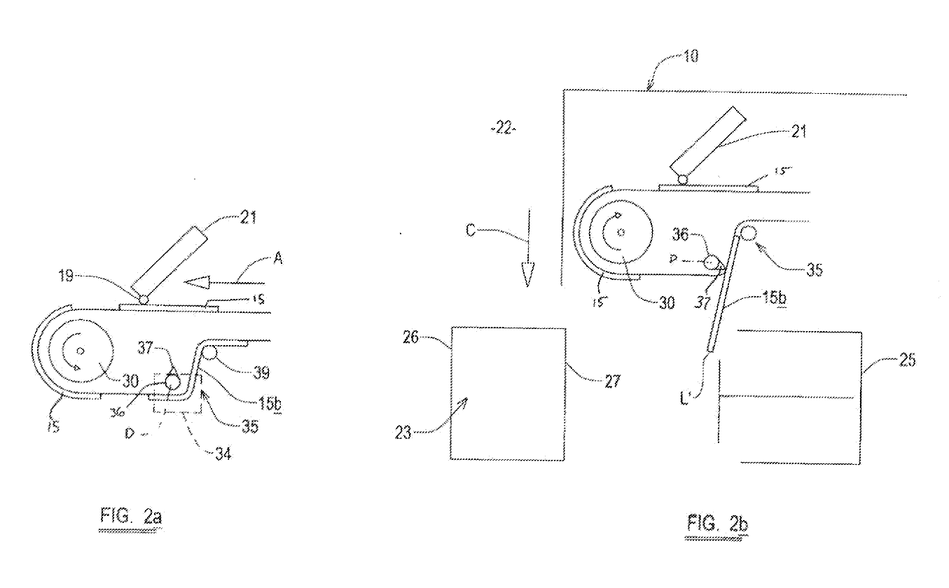

The appartus 10 further includes a take-up spool 16 for taking up of backing web 14 from which labels 15 have been removed. In the example, each of the storage and take-up spools 12, 16 are drivable by a motive device such one or more electric motors 17, 18 to feed the backing web 14 and labels 15 in either a first feed direction indicated by the arrow A in FIG. 1, or a reverse feed direction (indicated by arrow B in FIG. 2b).

The label handling device 10 includes a printing station 20 where a print head 21 is provided for printing on the labels 15. The print head 21 in this example is a thermal print heat having an array of heating elements which may be actuated under computer control to remove pixels of ink from a ribbon (not shown). In the example, the print head 21 is stationary during printing, with the necessary differential movement between the print head 21 and a label 15 (and ribbon) being achieved by feeding the label 15 (and ribbon) in the first feed direction A past the print head 21. In another example, feeding of a label 15 may be arrested at the print station 20 while printing is effected by moving the print head 21 relative to the stationary label 15 (and ribbon), or in yet another embodiment, each of the print head 21 and the label 15 (and ribbon) may be relative to a base structure of the label handling apparatus 10 during printing as desired.

Whereas in the example, the print head 21 has an array 19 of heating elements which are energized selectively under computer control to print pixels on the labels 15, the print head 21 could alternatively be any desired kind, of the label handling apparatus 10 may be operative only to handle pre-printed labels such that no print head 21 at all would be provided.

If desired, instead of a print head 21 or in addition thereto, where the labels 15 are of the kind which include an embedded data carrying device, such as an RFID tag, the label handling apparatus 10 may include a programming device for example to program the data carrying device.

In FIG. 1 the label handling apparatus 10 is shown configured to handle labels 15, in one orientation relative to a conveyor 22 along which packages 23 are in use conveyed in the direction indicated by arrow C. The label handling apparatus 10 is operated severally to remove labels 15 from the backing web 14, and to feed them in one label remove direction, to an adjacent label applicator 25 which receives the labels 15 and applies them to the one sides 26 of the articles 23 as they are conveyed, although if desired the articles 23 may each temporarily be halted on the conveyor 22 adjacent the label applicator 25 whilst a label 15 is applied.

Immediately after the printing station 20 in this example, the label handling apparatus 10 is provided with a web reversing guide roller 30 mounted adjacent which there is a label removing member namely a beak 31. The beak 31 includes an edge 32 which extends transversely of the direction of feed A of the backing web 14, and over which edge 32 the side surface of the backing web 14 opposite to the side surface on which the labels 15 are provided, passes. The edge 32 provides sharp discontinuity, and as the backing web 14 passes over the edge 32, a leading edge L of a label, for example label 15a illustrated in FIG. 1, tends to lift. As the backing web 14 continues to be fed past the edge 32, the label 15 is thus peeled and fed in the one label remove direction towards the label applicator 25.

In FIG. 1 it can be seen that the backing web 14 from which the labels 15 have been removed, passes to a downstream label removing station 35 to be described in more detail below, and is guided towards the take-up spool 16 to which the backing web 14 is fed as the backing web 14 continues to be moved in the first feed direction A.

If it is desired to apply labels 15 to second sides 27 of articles 23 opposite the first sides 26, conventionally the apparatus 10 would require substantial re-configuring, to ensure that the labels 15 are fed from the label handling apparatus 10 in a label remove direction which is substantially the same as the article convey direction indicated by arrow C in FIG. 1.

In accordance with the invention though, the apparatus 10 can be used substantially without re-configuring in an alternative orientation so that labels 15 may be applied to the second sides 27 of the articles 23.

Referring to FIGS. 2a and 2b, and in particular FIG. 2b, it can be seen that the label handling apparatus 10 has been re-located to the opposite side of the conveyor 22, and that the apparatus 10 has been re-orientated relative to the conveyor.

The label removing member, beak 31 (shown in FIG. 1) has been removed or moved out of the way, so that the backing web 14 now wraps around the reversing guide roller 30 without any sharp discontinuity being presented. Thus the backing web 14 and adhered labels 15 can be fed around the reversing guide roller 30 without any label 15 being peeled from the backing web 14.

As with the configuration of FIG. 1, the labels 15 may be printed (and/or RFID tags programmed) at the printing station 20 while the labels 15 move in direction A through the printing station 20.

The label removing station 35 downstream of the reversing roller 30 includes a label removing device 37 which is a beak, carried on a guide post 36. In FIG. 2a this is shown in an inoperative condition. The beak 37 is similar in construction in this example to the beak 31 of the label removing member 30, but in FIG. 2a the beak 37 is moved out of the way of the backing web 14, in this example by rotating the guide post 36 about an axis transverse to the direction A of backing web 14 feed, for example using a motive device such as an electric motor, solenoid or other controllable motive device, indicated at 34.

The label removing station 35 includes in this example, a guide roller 39 to guide the backing web 14 towards the take-up spool 16.

A printed (and/or RFID programmed) label 15b be removed from the backing web 14 is fed in the first backing web feed direction A past at least the guide post 36 and preferably downstream of the entire label removing station 35. As or when the backing web 14 is then halted, the guide post 36 is then rotated to bring the beak 37 to the operative condition as seen in FIG. 2B when the beak 37 will engage the side surface of the backing web 14 opposite to that on which the label 15b is releasably adhered. Next the backing web 14 and label 15 are fed in the reverse direction, i.e. direction B, by the motive device provided by the spool motors 17, 18 in this example, to move the backing web 14 and label 15b back past the beak 37. As the beak 37 provides a sharp discontinuity, a leading edge L′ of the label 15 i.e. the edge L leading during the reverse backing web feed, will become lifted and continued reverse backing web feed movement in direction B will cause the label 15b to be peeled from the backing web 14, and then fed in an alternative label removal direction to that indicated in FIG. 1 to an adjacent label applicator 25 which is also repositioned to the other side of the conveyor 22 to that indicated in FIG. 1.

It can be seen from FIG. 2b that the label 15b removed as a consequence of the reverse backing web movement in the second direction B, will be moving in generally the same direction during removal as the article 23 on the conveyor 22, and the label applicator 25 may be operated to apply the removed label 15b to the side 27 of an articles 23 opposite to the side 26 of the article 23 to which the label may be applied when the apparatus 10 is positioned and orientated as in FIG. 1.

When the label 15b has been peeled from the backing web 14, the backing web reverse movement may be halted and the backing web 14 moved again in the forward direction A to bring the next label 15 past the guide post 36 and label removing device 37, whilst the beak 37 is again moved to an inoperative position, hence for removal and applying to another article 23 by reversing the web feed direction and moving the beak 37 to its operative position as already described.

Various modification may be made to the apparatus 10 without departing from the scope of the invention.

For example the beak 37 may be moved to other operative positions to that shown in FIG. 2b so that during reverse backing web 14 movement a label 15 is removed from the backing web 14 in another label remove direction so that suggested in FIG. 2b, depending on the orientation of the apparatus 10 relative to the conveyor 22, or rather to the articles 23 conveyed thereby.

Instead of spool motors 17, 18 to drive the backing web 14 in both forward A and reverse B feed directions, another motive device, such as motor driven capstan roller may be provided, or the web 14 may be driven in one feed direction by a spool motor and in another direction by a capstan roller.

In an appropriate construction, the label removing device 37 may be rendered operative and inoperative otherwise than by rotation of the guide post 36. For example the beak 37 or other label removing device 37 may be otherwise moved between its operative and inoperative positions.

Although the invention has been described with reference to a label handling apparatus 10 in which labels 15 removed from the elongate backing web 14 are fed to a label applicator 25 and applied to articles 23 on a packaging line 22, the removed labels 15 may subsequent to removal from the backing web 14 as described, be otherwise subsequently handled.

1. A method of removing a label from an elongate backing web include the steps of feeding the backing web in first feed direction, with the label releasably adhered to the backing web, to feed the label past a label removing device whilst the label removing device is in an inoperative condition, reversing the feed direction of the backing web to feed the backing web in a second direction whilst the label removing device is in the operative condition to feed the label back past the operative label removing device, thus to cause the label to be removed from the backing web.

2. A method according to claim 1 wherein the method includes feeding the removed label in a label remove direction to a label applicator for subsequent application to an article.

3. A method according to claim 1 wherein the method includes the step of moving the label removing device from the inoperative condition to the operative condition prior to a leading edge of the label to be removed passing back beyond the label removing device when the feed direction is reversed.

4. A method according to claim 3 wherein the label removing device includes a beak over which the backing web passes when the label removing device is in an operative condition and the feed direction is reversed, with the beak at an opposite side surface of the backing web to the label, the beak providing a sharp discontinuity which causes the leading edge of the label to lift from the backing web, the continued reverse feed direction movement of the backing web peeling the label from the backing web.

5. A method according to claim 3 wherein the label removing device is rotatable between its inoperative and operative positions about an axis of rotation which is generally perpendicular to the directions of label feed.

6. A method according to claim 1 which included performing a work operation on the label while the backing web and label are upstream of the label removing device.

7. A method according to claim 6 wherein the work operation is performed while the backing web and label are moved in the first feed direction.

8. A method according to claim 6 wherein the method includes halting the backing web and label feed in the first direction whilst a work operation is performed on the label, and then recommencing backing web and label feed in the first direction to feed the label past the label removing device.

9. A method according to claim 1 wherein the label handling device includes a label removing member for removing labels when the backing web with labels is feed in the first direction, the method of the invention including removing or disabling such label removing member so that labels are not removed from the backing web when the backing web is fed in the first direction.

10. A method according to claim 1 which includes, subsequent to feeding the backing web in the second, reverse feed, direction to remove a label, feeding the backing web in the first feed direction to advance a further label releasably adhered to the backing web towards the label removing device.

11. A label handling apparatus including a storage spool for elongate backing web to which a plurality of labels are releasably adhered, and a take-up spool for backing web from which labels have been removed, a motive device operative to feed the backing web in a first feed direction, with labels releasably adhered to the backing web, past a label removing device whilst the label removing device is in an inoperative condition, and the motive device being operable to reverse the feed direction of the backing web to feed the backing web in a second direction whilst the label removing device is in an operative condition to feed labels back past the operative label removing device, thus to cause the labels to be removed from the backing web.

12. An apparatus according to claim 11 wherein the label removing device includes a beak over which the backing web passes when the label removing device is in an operative condition and the feed direction is reversed, with the beak at an opposite side surface of the backing web to the label, the beak providing a sharp discontinuity which, in use, causes the leading edge of the label to lift from the backing web, whilst continued reverse feed direction movement of the backing web peels the label from the backing web.

13. An apparatus according to claim 11 wherein the label removing device is rotatable between its inoperative and operative positions about an axis of rotation which is generally perpendicular to the directions of label feed.

14. An apparatus according to claim 11 wherein the label handling device includes a label removing member for removing labels when the backing web with labels is fed in the first feed direction, the member being capable of being disabled so that labels are not removed from the backing web when the backing web is fed in the fist direction.

15. An apparatus according to claim 11 which includes a motive device to move the label removing device between its operative and inoperative conditions.

16. A method of adapting a label handling apparatus which is configured for use in one orientation for use in an alternative orientation, the apparatus including a motive device which is operable to feed elongate backing web on which a plurality of labels are releasably adhered in a first direction and in a second direction, and a label removing member which is operable when the backing web and labels are fed in the first feed direction to remove labels from the backing web and to enable the removed labels to be fed in one label remove direction, the method including removing or disabling the label removing member, and operating a label removing device which is moveable between an inoperative condition in which when backing web and labels are fed past the label removing device in the first feed direction the label removing device is inoperative to remove labels from the backing web, and an operative condition in which when backing web and labels are fed past the label removing device in the second feed direction the label removing device is operative to remove labels from the backing web and removed labels are fed in an alternative label remove direction.
